(19) United States
(12) Patent Application Publication
(10) Pub. No.: US 2007/0093083 A1
(43) Pub. Date: Apr. 26, 2007

(54) Multi-purpose barrel sink

(76) Inventor: Brian Robert Bogison, Bozeman, MT (US)

Correspondence Address: BRIAN ROBERT BOGISON, 560 GOES NOWHERE ROAD, BOZEMAN, MT, 59715, US

(21) Appl. No.: 11/254,570

(22) Filed: Oct. 20, 2005

(51) Int. Cl. H01R 12/00

(52) U.S. Cl. 439/66

(57) ABSTRACT

A wood-stave barrel (3), its top removed, having a sink (5) fitted into the open top of the barrel. Standard drainpipes and traps (7) for allowing waste from the sink to exit the barrel. In an alternative embodiment, a wood-stave barrel (9), its top not removed, having an above-the-counter vessel sink (11) mounted onto the top of the barrel. Standard drainpipes and traps (13) for allowing waste from the vessel to exit the barrel. The sink or vessel is made of any suitable material that can contain water and other fluids.

### CROSS-REFERENCE TO RELATED APPLICATIONS

This application claims the benefit of provisional patent application Ser. No. 60/599,531, filed 2004 Aug. 4 by the present inventor. This application also claims the benefit of design patent applications titled “Barrel Sink” and “Barrel Cabinet,” filed 2004 Nov. 26 and 2004 Dec. 2 by the present inventor.

### FEDERALLY-SPONSORED RESEARCH

Not Applicable

### SEQUENCE LISTING OR PROGRAM

Not Applicable

### BACKGROUND OF THE INVENTION

1. Field of Invention

This invention relates to wash basins and/or sinks.

2. Prior Art

Barrels are primarily used for containing and transporting goods. Many alternative uses for barrels have been devised over the years to assist people with everyday tasks. One such example is the half-barrel washtub. A wood-stave barrel is cut in half to create a vessel or open container that is filled with water and soap for washing, and then dumped out. The problem with the half-barrel washtub is that water and soap make direct contact with the inside of the barrel, making it difficult to clean and deteriorating the barrel over time. It also lacks the ability to couple into modern plumbing systems and, for that reason, it is unable to accept water supplied to it and deal with the waste at the same time.

U.S. Pat. No. 4,460,221, granted to Dimino Jul. 17, 1984, describes a wine barrel bar in which a common wood-stave barrel is given alternative use as a decorative display and storage for wine bottles and glasses.

### OBJECTS AND ADVANTAGES

Accordingly, besides the objects and advantages of the barrel sink described in my provisional patent application, several objects and advantages of the present invention are:
(A) to provide a novel, multi-purpose sink which can be utilized in a variety of household and commercial applications;
(B) to provide a durable and aesthetically-pleasing sink which can be accessed from virtually every angle of approach;
(C) to provide a sink which can be installed against the wall or in the center of the room;
(D) to offer an improvement to the use and function of any suitable wood-stave barrel, especially those coopered for wine, whisky, or beer.

Further objects and advantages are to provide a sink which is fully compliant with the specifications of modern plumbing, which utilizes new, used and bootleg barrels as a durable under cabinet for a sink, and which gives the installer multiple options for placement, particularly in limited spaces.

### SUMMARY

In accordance with the present invention a wood-stave barrel comprising a sink and drain system for allowing waste from the sink to exit the barrel.

### DRAWINGS—FIGURES

FIG. 1 is a frontal view of the barrel sink of the present invention, being shown with a large cutout in order to expose the inner workings of the sink.

FIG. 2 is a frontal view of the barrel sink of the present invention, being shown in an alternative embodiment with a large cutout in order to expose the inner workings of the sink.

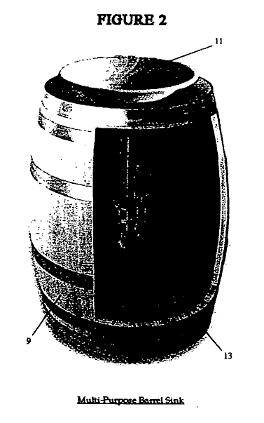

### DRAWINGS—REFERENCE NUMERALS

3. wood-stave barrel (with large cutout)
5. sink
7. drain system
9. wood-stave barrel (with large cutout)
11. vessel sink
13. drain system

### DESCRIPTION

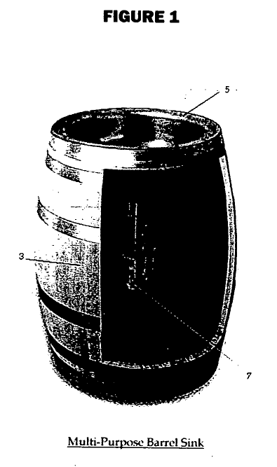

A preferred embodiment of the barrel sink of the present invention is illustrated in FIG. 1 (frontal view shown with cutout). The top is removed from a wood-stave barrel (3). A sink (5) made of any suitable material for containing water or other fluids is fitted into the open top of the barrel. A drain system (7) having the appropriate holes, pipes, and traps couples into the sink and allows waste from the sink to exit the barrel.

### Alternative Embodiments

In an alternative embodiment, a wood-stave barrel (9), its top not removed, having an above-the-counter vessel sink (11) mounted onto the top of the barrel. A drain system (13) having the appropriate holes, pipes, and traps couples into the vessel and allows waste from the vessel to exit the barrel. The vessel is made of any suitable material that can contain water and other fluids.

Again, the objects and advantages of the barrel sink of the present invention are to provide a novel, multi-purpose sink which couples into modern plumbing systems and utilizes wood-stave barrels of varying condition for an alternative purpose. The present invention gives the user a comfortable standing sink that can accessed from virtually every angle of approach and offers the installer multiple options for placement, particularly in limited spaces.

1. In a wash basin of the type comprising a wood-stave barrel and fitted sink, the improvement wherein a drain system couples into said sink, allowing waste to exit said barrel.

2. The wash basin of claim 1 wherein said barrel has its top removed.

3. The wash basin of claim 2 wherein said sink inserts into the open top of said barrel.

4. The wash basin of claim 1 wherein said sink is composed of any suitable material for containing water and other fluids.

5. In a wash basin of the type comprising a wood-stave barrel and above-the-counter vessel sink, characterized in that the top of said barrel remains as a mounting surface for said vessel sink.

6. The wash basin of claim 5 wherein the top of said barrel is not removed.

7. The wash basin of claim 5 wherein a drain system couples into said vessel sink through the top of said barrel.
